(19) United States
(12) Patent Application Publication
(10) Pub. No.: US 2022/0326901 A1
(43) Pub. Date: Oct. 13, 2022

(54) DATA DISPLAY

(71) Applicant: BEIJING SANKUAI ONLINE TECHNOLOGY CO., LTD., Beijing (CN)

(72) Inventors: Dahu ZHANG, Beijing (CN); Jingtao WANG, Beijing (CN); Liang SHEN, Beijing (CN)

(21) Appl. No.: 17/850,016

(22) Filed: Jun. 27, 2022

Related U.S. Application Data
(63) Continuation of application No. PCT/CN2020/112592, filed on Aug. 31, 2020.

(30) Foreign Application Priority Data
Mar. 19, 2020 (CN) 202010198380.X

(51) Int. Cl. G06F 3/14

(52) U.S. Cl. CPC G06F 3/1423

(57) ABSTRACT

A data display method is provided, including: using every two services as one service group, and calculating two-way service indicators of service groups based on service data of the service groups; establishing a display unit array based on a quantity of services; and dividing each display unit into two regions, and displaying the two-way service indicators of each service group in the two regions of the corresponding display unit in a mirrored manner.

### CROSS REFERENCE TO RELATED APPLICATION

This application is a continuation application of international application No. PCT/CN2020/112592, filed on Aug. 31, 2020, which claims priority to Chinese Patent Application No. 202010198380.X, filed on Mar. 19, 2020 and entitled “DATA PRESENTATION METHOD AND APPARATUS, ELECTRONIC DEVICE AND COMPUTER-READABLE MEDIUM”, the disclosures of which are herein incorporated by reference in their entireties.

### TECHNICAL FIELD

Embodiments of the disclosure relate to the field of computer technologies, and specifically to data display.

### BACKGROUND

With the development of internet technology, services are usually deployed on each platform, and there is usually a two-way cross relationship between services. Using a browsing scenario as an example, a user continues to browse a service B after browsing a service A, and another user browses the service A after browsing the service B. In this case, it may be considered that the service A and the service B have a two-way relationship. When a platform has many types of services, visualization of the two-way cross relationship between services and related data (such as a plurality of indicators) can facilitate service analysis and platform improvement.

### SUMMARY

Embodiments of the present disclosure provide data display.

According to an aspect, an embodiment of the present disclosure provides a data display method, including: using every two services as one service group, and calculating two-way service indicators of service groups based on service data of the service groups; establishing a display unit array based on a quantity of services, each service group having a corresponding display unit in the display unit array; and dividing each display unit into two regions, and displaying the two-way service indicators of each service group in the two regions of the corresponding display unit in a mirrored manner.

According to an aspect, an embodiment of the present disclosure provides a data display apparatus, including: a calculation unit, configured to use every two services as one service group, and calculate two-way service indicators of service groups based on service data of the service groups; an establishment unit, configured to establish a display unit array based on a quantity of services, each service group having a corresponding display unit in the display unit array; and a display unit, configured to divide each display unit into two regions, and display the two-way service indicators of each service group in the two regions of the corresponding display unit in a mirrored manner.

According to an aspect, an embodiment of the present disclosure provides an electronic device, including: one or more processors; and a storage apparatus, storing one or more programs, the one or more programs, when executed by the one or more processors, causing the one or more processors to implement any data display method according to the embodiments of the disclosure.

According to another aspect, an embodiment of the present disclosure provides a non-transitory computer-readable medium, storing a computer program, the program, when executed by a processor, implementing any data display method according to the embodiments of the disclosure.

According to a data display method and apparatus, an electronic device, and a non-transitory computer-readable medium that are provided in the embodiments of the present disclosure, every two services are used as one service group, and two-way service indicators of service groups are calculated based on service data of the service groups; a display unit array is then established based on a quantity of services; and each display unit is finally divided into two regions, so that the two-way service indicators of each service group are displayed in the two regions of the corresponding display unit in a mirrored manner. On the one hand, because the two-way service indicators of each service group can be displayed in the corresponding display unit, and the display units corresponding to the service groups can be concentrated in one display unit array, the display unit array accommodates service indicators of a plurality of services having a two-way cross relationship. Therefore, such a display manner supports displaying data of services having the two-way relationship. In addition, the two-way service indicators of the service groups are displayed in the corresponding display units in a mirrored manner, which can display the two-way relationship between the services directly and clearly. Compared with the display manner of a social network graph, the disclosure improves the readability of the displayed data. On the other hand, the services may be randomly combined, and the quantity of service indicators may be customized. When the quantity of service types increases, the display unit array may be expanded to accommodate more display units. Compared with the existing data display manner, the disclosure enhances the scalability during data display.

### BRIEF DESCRIPTION OF THE DRAWINGS

FIG. 1 is a flowchart of an embodiment of a data display method according to the present disclosure;

FIG. 2 is a schematic diagram of a layout style of display units corresponding to service groups in a display unit array according to the present disclosure;

FIG. 3 is another schematic diagram of a layout style of display units corresponding to service groups in a display unit array according to the present disclosure;

FIG. 4 is a schematic diagram of a correspondence between different quantities of service indicators and layout styles according to the present disclosure;

FIG. 5 is a schematic diagram of a data display result according to the present disclosure;

FIG. 6 is a schematic structural diagram of an embodiment of a data display apparatus according to the present disclosure; and

FIG. 7 is a schematic structural diagram of a computer system adapted to implementing an electronic device according to an embodiment of the present disclosure.

### DETAILED DESCRIPTION

The disclosure is further described in detail below with reference to the accompanying drawings and embodiments. It may be understood that specific embodiments described herein are only used to explain a related disclosure, but not to limit the disclosure. In addition, it should be noted that, for ease of description, the accompanying drawings only show parts relevant to the related disclosure.

It should be noted that, the embodiments in the disclosure and features in the embodiments may be combined with each other in the case of no conflict. The disclosure is described in detail below with reference to the accompanying drawings and the embodiments.

In the related art, visualization of data and service relationships is usually implemented by a basic chart (for example, a bar chart, a column chart, or a pie chart), a Sankey diagram, and a social network graph. However, the basic chart generally fails to display a two-way cross relationship between services. The Sankey diagram can only display data having a one-way relationship and a single indicator, and cannot display data having a two-way relationship and a plurality of indicators. Although the social network graph can display the two-way relationship, the social network graph generally fails to differentiate directions, and the readability of the social network graph is lower when more services are involved. Therefore, the data display method in the related art cannot be adapted to displaying service data having a two-way relationship, and the readability thereof is usually lower when data of various services needs to be displayed.

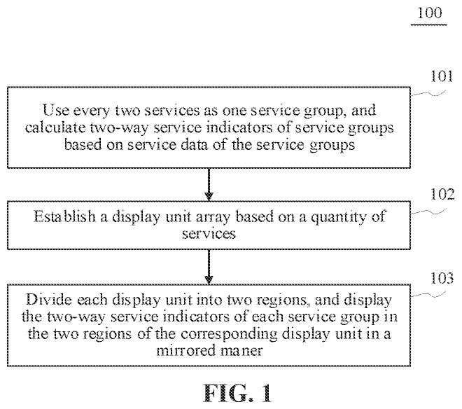

In view of this, an embodiment of the present disclosure provides a data display method. FIG. 1 shows a procedure 100 of an embodiment of a data display method according to the present disclosure. An execution entity of the data display method may be various electronic devices with a display screen, including smartphones, tablet computers, laptops, desktop computers, etc. The data display method includes the following step 101 to step 103.

Step 101. Use every two services as one service group, and calculate two-way service indicators of service groups based on service data of the service groups.

In this embodiment, the execution entity of the data display method may first traverse every two services in a platform, and use every two traversed services as one service group. In an example, if there are four services: a service A, a service B, a service C, and a service C respectively, and every two services are used as one service group, six service groups can be formed: the service A and the service B, the service A and the service C, the service A and the service D, the service B and the service C, the service B and the service D, and the service C and the service D.

In practice, services in a platform generally have a two-way cross relationship, and the two-way cross relationship may mean that a two-way relationship exists between two services in the platform. In an example, when resources are mutually outputted between two services, it may be considered that a two-way relationship exists between the two services. The resource herein may include, but is not limited to, transaction traffic, access traffic, etc. Correspondingly, the output of the resource may mean that browsing users (belonging to the access traffic) is outputted by one service to another service, or payment traffic (belonging to the transaction traffic) is outputted by one service to another service.

In an example, in a browsing scenario, a user continues to browse the service B after browsing the service A, and another user browses the service A after browsing the service B. In this case, it may be considered that access traffic is diverted between the service A and the service B, and it may be considered that a two-way relationship exists between the service A and the service B.

In another example, in a payment scenario, a user first pays for the service A, and then pays for the service B. Another user first pays for the service B, and then pays for the service A. In this case, it may be considered that transaction traffic is diverted between the service A and the service B, and it may be considered that a two-way relationship exists between the service A and the service B.

In this embodiment, after the service groups are established, the execution entity may calculate the two-way service indicators of the service groups based on the service data of the service groups. For each service, service data of the service may include, but is not limited to, total resources (for example, total access traffic and total transaction traffic) of the service, resources outputted by the service to other services, resources inputted by other services to the service, etc.

For each service group, the two-way service indicators of the service group may be service indicators calculated based on resources mutually outputted by two services in the service group, and different output directions of the resources correspond to different service indicators in the two-way service indicators.

In some embodiments, the two-way service indicators of each service group may include a first service indicator and a second service indicator, and the first service indicator and the second service indicator of each service group correspond to each other in a one-to-one manner. There may be one or more first service indicators and one or more second service indicators. In this case, the execution entity may calculate the first service indicator and the second service indicator according to the following steps. First, cross resources of two services in each service group are determined based on the service data of each service group. The cross resources include resources that are mutually outputted. Then, the first service indicator and the second service indicator corresponding to different output directions of the resources may be calculated based on the cross resources of each service group.

Specifically, the execution entity may first use one service (such as, the service A) in each service group as an upstream service, and use the other service (such as, the service B) as a downstream service. The upstream service is used for outputting a resource to the downstream service, and the downstream service is used for obtaining the resource outputted by the upstream service. Then, the execution entity calculates the first service indicator based on a first resource outputted by the upstream service to the downstream service (that is, an output direction of the first resource is from the upstream service to the downstream service, namely, from the service A to the service B). Finally, the execution entity may interchange the upstream service and the downstream service of each service group, and calculate the second service indicator based on a second resource outputted by the interchanged upstream service (namely, the service B) to the interchanged downstream service (namely, the service A) (that is, an output direction of the second resource is from the interchanged upstream service to the interchanged downstream service, namely, from the service B to the service A). The cross resources include the first resource and the second resource.

In a scenario, the first service indicator may include the first resource and a proportion of the first resource in total resources of the upstream service. The second service indicator may include the second resource and a proportion of the second resource in total resources of the interchanged upstream service.

In an example, when the resource is access traffic, the first service indicator may include daily access traffic (for example, diverted browsing users) outputted by the service A to the service B and a proportion of the access traffic in total access traffic of the service A. The second service indicator may include daily access traffic outputted by the service B to the service A and a proportion of the access traffic in total access traffic of the service B. The total access traffic herein may be daily active users (DAUs).

In another example, when the resource is transaction traffic, the first service indicator may include daily transaction traffic (for example, diverted transactional users) outputted by the service A to the service B and a proportion of the transaction traffic in total transaction traffic of the service A. The second service indicator may include daily transaction traffic outputted by the service B to the service A and a proportion of the transaction traffic in total transaction traffic of the service B. The total transaction traffic herein may be daily transactional users (DTUs).

In another scenario, the first service indicator may include the first resource and a proportion of the first resource in total resources of the downstream service. The second service indicator may include the second resource and a proportion of the second resource in total resources of the interchanged downstream service.

In an example, when the resource is access traffic, the first service indicator may include daily access traffic outputted by the service A to the service B and a proportion of the access traffic in total access traffic of the service B. The second service indicator may include daily access traffic outputted by the service B to the service A and a proportion of the access traffic in total access traffic of the service A. The total access traffic herein may be DAUs.

In another example, when the resource is transaction traffic, the first service indicator may include daily transaction traffic outputted by the service A to the service B and a proportion of the transaction traffic in total transaction traffic of the service B. The second service indicator may include daily transaction traffic outputted by the service B to the service A and a proportion of the transaction traffic in total transaction traffic of the service A. The total transaction traffic herein may be DTUs.

In still another scenario, the first service indicator includes the first resource, a proportion of the first resource in total resources of the upstream service, and a proportion of the first resource in total resources of the downstream service. The second service indicator includes the second resource, a proportion of the second resource in total resources of the interchanged upstream service, and a proportion of the second resource in total resources of the interchanged downstream service.

In an example, when the resource is access traffic, the first service indicator may include daily access traffic outputted by the service A to the service B, a proportion of the access traffic in total access traffic of the service A, and a proportion of the access traffic in total access traffic of the service B. The second service indicator may include daily access traffic outputted by the service B to the service A, a proportion of the access traffic in the total access traffic of the service B, and a proportion of the access traffic in the total access traffic of the service A. The total access traffic herein may be DAUs.

In still another example, when the resource is transaction traffic, the first service indicator may include daily transaction traffic outputted by the service A to the service B, a proportion of the transaction traffic in total transaction traffic of the service A, and a proportion of the transaction traffic in total transaction traffic of the service B. The second service indicator may include daily transaction traffic outputted by the service B to the service A, a proportion of the transaction traffic in the total transaction traffic of the service B, and a proportion of the transaction traffic in the total transaction traffic of the service A. The total transaction traffic herein may be DTUs.

It should be noted that, a quantity of the first service indicators and a quantity the second service indicators of each service group may be set to a same value generally, and the quantity may be set as required, which may be one or more. The quantity of set indicators is not limited in this embodiment of the disclosure.

In addition, specific indicator items in the first service indicator and the second service indicator may be set based on actual requirements, which are not limited in the disclosure.

In addition, the service indicator may be in a form of a number, a text (for example, a label, conclusion, etc.), and the form of the service indicator is not limited in this embodiment of the disclosure.

In some embodiments, different rows of a display unit array correspond to different services, and different columns of the display unit array correspond to different services; and the first service indicator of each service group is a service indicator determined by using a service corresponding to a column in which a corresponding display unit is located as the upstream service and using a service corresponding to a row in which the corresponding display unit is located as the downstream service, and the second service indicator of each service group is a service indicator determined by using a service corresponding to a row in which a corresponding display unit is located as the upstream service and using a service corresponding to a column in which the corresponding display unit is located as the downstream service. Therefore, the upstream service and the downstream service during calculation of the service indicators of each service group are set uniformly, which can ensure the consistency of positions of the service indicators that are subsequently displayed.

Alternatively, the first service indicator of each service group is a service indicator determined by using a service corresponding to a row in which a corresponding display unit is located as the upstream service and using a service corresponding to a column in which the corresponding display unit is located as the downstream service, and the second service indicator of each service group is a service indicator determined by using a service corresponding to a column in which a corresponding display unit is located as the upstream service and using a service corresponding to a row in which the corresponding display unit is located as the downstream service. Therefore, the upstream service and the downstream service during calculation of the service indicators of each service group are set uniformly, which can ensure the consistency of positions of the service indicators that are subsequently displayed.

Step 102. Establish a display unit array based on a quantity of services.

In this embodiment, the execution entity may establish the display unit array based on the quantity of services, so that each service group has a corresponding display unit in the display unit array. For example, the quantity of services may be used as the quantity of rows or columns, to establish a display unit array with the same quantity of rows and columns or a display unit array with different quantities of rows and columns.

In some embodiments, the execution entity may first determine the quantity of rows and the quantity of columns of the display unit array based on the quantity of services. The quantity of rows and the quantity of columns of the display unit array may be the same or different, and are not limited in this embodiment of the disclosure. For example, the quantity of services (such as 10) may be used as the quantity of rows and the quantity of columns, to establish a display unit array (such as a 10*10 display unit array, which can accommodate 100 display units). Then, the execution entity may map different services to different rows according to a preset service arrangement order, and map different services to different columns according to the service arrangement order, to establish the display unit array including the display units corresponding to the service groups. It should be noted that, some display units in the display unit array may not display data. For example, if a row and a column in which a display unit is located correspond to a same service, the display unit may display no content.

It should be noted that, for different data display requirements, the display units corresponding to the service groups may have different layouts in the display unit array. Therefore, in some embodiments, after establishing the display unit array, the execution entity may determine, based on a preset data display requirement, a layout of display units for displaying data in the display unit array; and then determine, based on the layout, the display units corresponding to the service groups in the display unit array.

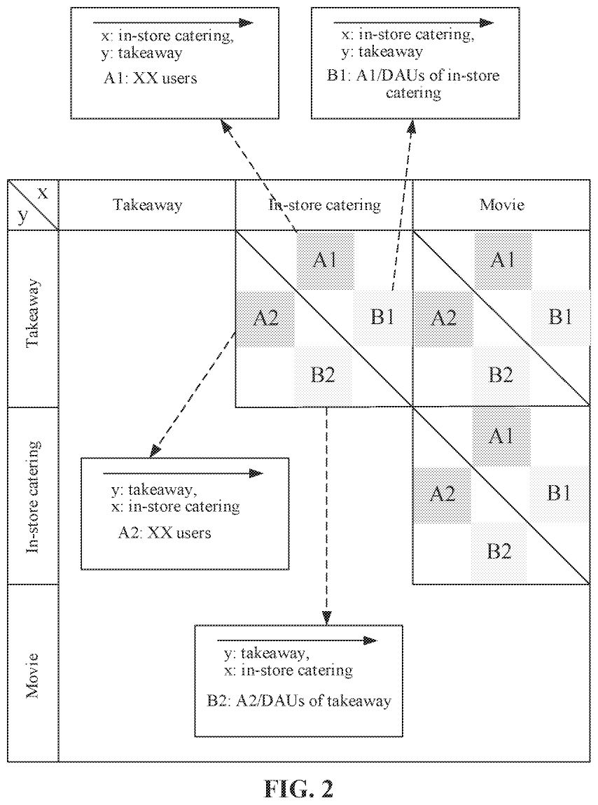

In an example, if resources outputted by each service to other services need to be analyzed, a proportion of a resource outputted by an upstream service to a downstream service in total resources of the upstream service needs to be displayed. In this case, the display units corresponding to the service groups may be deployed according to a style shown in FIG. 2. That is, the display units corresponding to the service groups are deployed in an upper right part of the display unit array.

Three services: a takeaway service, an in-store catering service (a user arrives at a designated location and dines, where catering is provided at the designated location, for example, the designated location is a restaurant or a beverage shop), and a movie service, are used as an example. As shown in FIG. 2, two-way service indicators of each service group include access traffic A1 outputted by an upstream service to a downstream service and a proportion B1 of the access traffic in total access traffic of the upstream service; and include, after the upstream service and the downstream service are interchanged, access traffic A2 outputted by the interchanged upstream service to the downstream service and a proportion B2 of the access traffic in total access traffic of the interchanged upstream service.

As shown in FIG. 2, a display unit array with three rows and three columns may be established based on the quantity of services. The display unit array can accommodate nine display units. If a transverse direction is used as an x axis, and a longitudinal direction is used as a y axis, the execution entity may use, from top to bottom and from left to right, each service as an upstream service, and perform light reflection (or, light irradiation) by using the upstream service as a “light source” and a diagonal line in the display unit as a “mirror”, where a light incident direction corresponds to the upstream service, and an emitting direction corresponds to a downstream service. Therefore, for a service group of x=in-store catering and y=takeaway, according to the direction from top to bottom, x=in-store catering may be used as the upstream service, and y=takeaway may be used as the downstream service, to determine a daily absolute amount A1 diverted from the in-store catering service to the takeaway service may be determined, for example, access traffic of “0.XX million”. Meanwhile, a proportion B1 of A1 in DAUs of the in-store catering service may be calculated. Then, according to the direction from left to right, y=takeaway may be used as the upstream service, and x=in-store catering may be used as the downstream service, to determine a daily absolute amount A2 diverted from the takeaway service to the in-store catering service, for example, access traffic of “0.XX million”. Meanwhile, a proportion B2 of A2 in total DAUs of the takeaway service may be calculated. It should be noted that, for other service groups, numerical values of two-way service indicators may be determined in similar manners, and details are not repeated herein again.

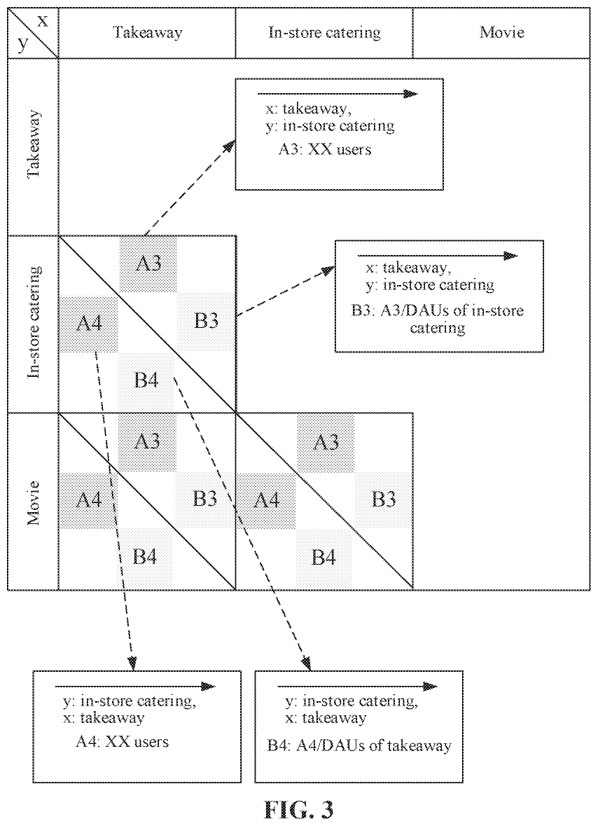

In another example, if a main source of resources of each service needs to be analyzed, a proportion of a resource outputted by an upstream service to a downstream service in total resources of the downstream service needs to be displayed. In this case, the display units corresponding to the service groups may be deployed according to a style shown in FIG. 3. That is, the display units corresponding to the service groups are deployed in a lower left part of the display unit array.

The three services: the takeaway service, the in-store catering service, and the movie service are still used as an example. As shown in FIG. 3, two-way service indicators of each service group include access traffic A3 outputted by an upstream service to a downstream service and a proportion B3 of the access traffic in total access traffic of the upstream service; and include, after the upstream service and the downstream service are interchanged, access traffic A4 outputted by the interchanged upstream service to the downstream service and a proportion B4 of the access traffic in total access traffic of the interchanged upstream service.

As shown in FIG. 3, a display unit array with three rows and three columns may be established based on the quantity of services. The display unit array can accommodate nine display units. If a transverse direction is used as an x axis, and a longitudinal direction is used as a y axis, the execution entity may use, from top to bottom and from left to right, each service as an upstream service, and perform light reflection by using the upstream service as a “light source” and a diagonal line in the display unit as a “mirror”, where a light incident direction corresponds to the upstream service, and an emitting direction corresponds to a downstream service. Therefore, for a service group of x=takeaway and y=in-store catering, according to the direction from top to bottom, x=takeaway may be used as the upstream service, and y=in-store catering may be used as the downstream service, to determine a daily absolute amount A3 diverted from the takeaway service to the in-store catering service, for example, access traffic of “0.XX million”. Meanwhile, a proportion B3 of A3 in DAUs of the in-store catering service may be calculated. Then, according to the direction from left to right, y=in-store catering may be used as the upstream service, and x=takeaway may be used as the downstream service, to determine a daily absolute amount A4 diverted from the in-store catering service to the takeaway service, for example, access traffic of “0.XX million”. Meanwhile, a proportion B4 of A4 in total DAUs of the takeaway service may be calculated.

It should be noted that, when there are the above two data display requirements at the same time, the layouts shown in FIG. 2 and FIG. 3 may be combined. Details are not described herein again. In addition, layouts of different requirements may also be set in other manners as required, which are not limited to the above examples.

Step 103. Divide each display unit into two regions, and display the two-way service indicators of each service group in the two regions of the corresponding display unit in a mirrored manner.

In this embodiment, the execution entity may divide each display unit into the two regions, and display the two-way service indicators of each service group in the two regions of the corresponding display unit in a mirrored manner. In addition, the two regions may be divided in various manners, for example, the two regions are divided by a diagonal line or a central line. The two-way service indicators of each service group are the service indicators calculated based on the resources mutually outputted by the two services in the service group, and different output directions of the resources correspond to different service indicators in the two-way service indicator. Therefore, for a display unit, service indicators corresponding to different output directions may be displayed in different regions of the display unit respectively.

In some embodiments, service indicators included by the two-way service indicators of each service group may be divided into the first service indicator and the second service indicator according to the output directions of the resources. The first service indicator and the second service indicator of each service group correspond to each other in a one-to-one manner. In this case, a diagonal line may be first drawn in each display unit. Then, the first service indicator of each service group is displayed at one side of the diagonal line of the corresponding display unit, and the second service indicator of each service group is displayed at the other side of the diagonal line of the corresponding display unit in a mirrored manner.

In some embodiments, the displaying the first service indicator at one side of the diagonal line of the corresponding display unit, and displaying the second service indicator of each service group at the other side of the diagonal line of the corresponding display unit in a mirrored manner may be specifically performed according to the following substep S11 to substep S13.

Substep S11. Set, based on a quantity of first service indicators of each service group, display positions of the first service indicators of each service group at one side of the diagonal line of the corresponding display unit. For different quantities of the first service indicators, layout styles of the first service indicators at one side of the diagonal line of the display unit may be preset.

Substep S12. Set, based on the display positions of the first service indicators of each service group, mirror positions of second service indicators of each service group at the other side of the diagonal line of the corresponding display unit.

In an example, FIG. 4 is a schematic diagram of a correspondence between different quantities of service indicators and layout styles. As shown in FIG. 4, when there is one first service indicator, there is also one second service indicator. In this case, the display unit may be divided into four subunits uniformly, the first service indicator (such as A1) is displayed in a subunit of a first row and a second column, and the second service indicator (such as A2) is displayed in a subunit of a second row and a first column.

Still referring to FIG. 4, when there are two first service indicators, there are also two second service indicators. In this case, the display unit may be divided into nine subunits uniformly, the first service indicators (such as A1 and B1) are displayed in a subunit of a first row and a second column and a subunit of a second row and a third column respectively, and the second service indicators (such as A2 and B2) are displayed in a subunit of the second row and a first column and a subunit of a third row and the second column respectively.

Still referring to FIG. 4, when there are three first service indicators, there are also three second service indicators. In this case, the display unit may be divided into nine subunits uniformly, the first service indicators (such as A1, B1, and C1) are displayed in a subunit of a first row and a second column, a subunit of the first row and a third column, and a subunit of a second row and the third column respectively, and the second service indicators (such as, A2, B2, and C2) are displayed in a subunit of the second row and a first column, a subunit of a third row and the first column, and a subunit of the third row and the second column.

Still referring to FIG. 4, when there are four first service indicators, there are also four second service indicators. In this case, the display unit may be divided into 16 subunits uniformly, the first service indicators (such as A1, B1, C1, and D1) are displayed in a subunit of a first row and a third column, a subunit of the first row and a fourth column, a subunit of a second row and the third column, and a subunit of the second row and the fourth column respectively, and the second service indicators (such as A2, B2, C2, and D2) are displayed in a subunit of a third row and a first column, a subunit of the third row and a second column, a subunit of a fourth row and the first column, and a subunit of the fourth row and the second column respectively.

Alternatively, when there are four first service indicators, the first service indicators (such as A1, B1, C1, and D1) may be displayed in a subunit of a first row and a second column, a subunit of the first row and a third column, a subunit of a second row and a fourth column, and a subunit of a third row and the fourth column respectively, and the second service indicators (such as, A2, B2, C2, and D2) may be displayed in a subunit of the second row and a first column, a subunit of the third row and the first column, a subunit of a fourth row and the second column, and a subunit of the fourth row and the third column respectively.

Still referring to FIG. 4, when there are five first service indicators, there are also five second service indicators. In this case, the display unit may be divided into 16 subunits uniformly, the first service indicators (such as A1, B1, C1, D1, and E1) are displayed in a subunit of a first row and a second column, a subunit of the first row and a third column, a subunit of the first row and a fourth column, a subunit of a second row and the fourth column, and a subunit of a third row and the fourth column respectively, and the second service indicators (such as A2, B2, C2, D2, and E2) are displayed in a subunit of the second row and a first column, a subunit of the third row and the first column, a subunit of a fourth row and the first column, a subunit of the fourth row and the second column, and a subunit of the fourth row and the third column respectively.

Still referring to FIG. 4, when there are six first service indicators, there are also six second service indicators. In this case, the display unit may be divided into 16 subunits uniformly, the first service indicators (such as A1, B1, C1, D1, E1, and F1) are displayed in a subunit of a first row and a second column, a subunit of the first row and a third column, a subunit of the first row and a fourth column, a subunit of a second row and the third column, a subunit of the second row and the fourth column, and a subunit of a third row and the fourth column respectively, and the second service indicators (such as A2, B2, C2, D2, E2, and F2) are displayed in a subunit of the second row and a first column, a subunit of the third row and the first column, a subunit of the third row and the second column, a subunit of a fourth row and the first column, a subunit of the fourth row and the second column, and a subunit of the fourth row and the third column respectively.

It should be noted that, the quantity of service indicators is not limited, and when there are more service indicators, the service indicators may be deployed by dividing the display unit into more subunits. The disclosure does not list cases of more service indicators one by one.

Substep S13. Display, based on the determined display positions and mirror positions, the corresponding first service indicators and second service indicators in the display unit corresponding to each service group.

Specifically, the first service indicators of each service group may be displayed in the determined display positions in a corresponding display region respectively, and the second service indicators of each service group may be displayed in the determined mirror positions in a corresponding display region respectively.

In some embodiments, after the two-way service indicators of each service group are displayed in the two regions of the corresponding display unit in a mirrored manner, the execution entity may further detect conditions satisfied by the service indicators in each display unit, and set, based on display styles associated with the conditions, display styles of the service indicators in each display unit. Exemplarily, the display styles include, but are not limited to, at least one of background depth, background color, font, and special symbol.

In an example, if the service indicators are numerical values, a service indicator greater than a specific preset value may be set to one style, and a service indicator less than the preset value may be set to another style. “A service indicator greater than a specific preset value” is that “the service indicator satisfies a condition of being greater than the specific preset value”, “one style” is “a display style associated with the condition of being greater than the specific preset value”, “a service indicator less than the preset value” is that “the service indicator satisfies a condition of being less than the specific preset value”, and “another style” is “a display style associated with the condition of being less than the specific preset value”.

In another example, when there are two or more groups of two-way service indicators (for example, a first group of two-way service indicators is a first service indicator A1 and a second service indicator A2, a second group of two-way service indicators is a first service indicator B1 and a second service indicator B2, etc.), different groups of service indicators (which means that service indicators satisfy a condition of “belonging to a specific group”) may be set to different styles (namely, a display style associated with the condition of “belonging to a specific group”). In addition, different conditions may be set for each type of service indicators, so that the same type of indicators may be displayed in different styles.

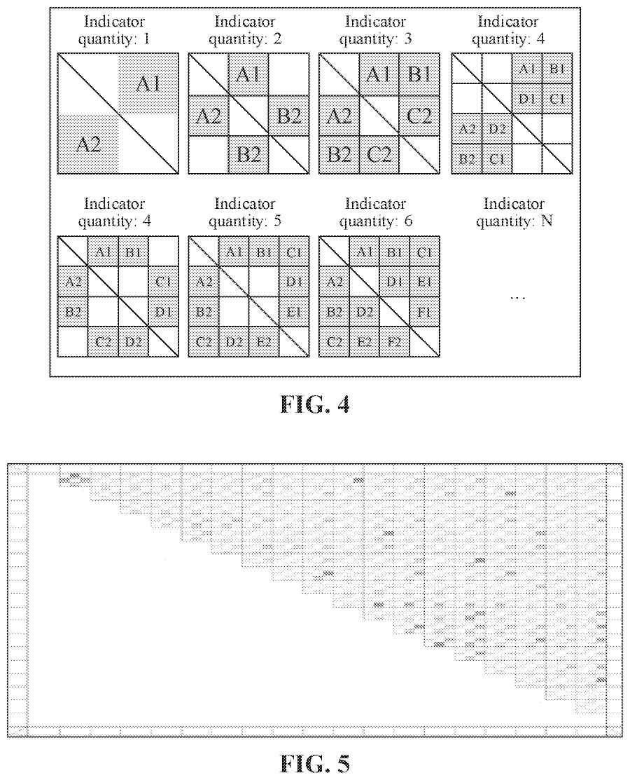

FIG. 5 is a schematic diagram of a data display result. Based on the conditions satisfied by the service indicators, the background depths (or colors) of the service indicators in the display units may be different. It should be noted that, In FIG. 5, each row may indicate a service, and each column may indicate a service. Therefore, a name or identification of a service may also be recorded in the row and column (not marked on the figure), thereby facilitating data viewing and analysis. In addition, as shown in FIG. 2, a first group of two-way service indicators is a first service indicator A1 and a second service indicator A2, which are displayed in a darker background. A second group of two-way service indicators is a first service indicator B1 and a second service indicator B2, which are displayed in a lighter background.

According to the method provided in the embodiments of the present disclosure, every two services are used as one service group, and two-way service indicators of service groups are calculated based on service data of the service groups; a display unit array is then established based on a quantity of services; and each display unit is finally divided into two regions, so that the two-way service indicators of each service group are displayed in the two regions of the corresponding display unit in a mirrored manner. On the one hand, because the two-way service indicators of each service group can be displayed in the corresponding display unit, and the display units corresponding to the service groups can be concentrated in one display unit array, the display unit array accommodates service indicators of a plurality of services having a two-way cross relationship. Therefore, such a display manner supports displaying data of services having the two-way relationship. In addition, the two-way service indicators of the service groups are displayed in the corresponding display units in a mirrored manner, which can display the two-way relationship between the services directly and clearly. Compared with the display manner of a social network graph, the disclosure improves the readability of the displayed data. On the other hand, the services may be randomly combined, and the quantity of service indicators may be customized. When the quantity of service types increases, the display unit array may be expanded to accommodate more display units. Compared with the existing data display manner, the disclosure enhances the scalability during data display.

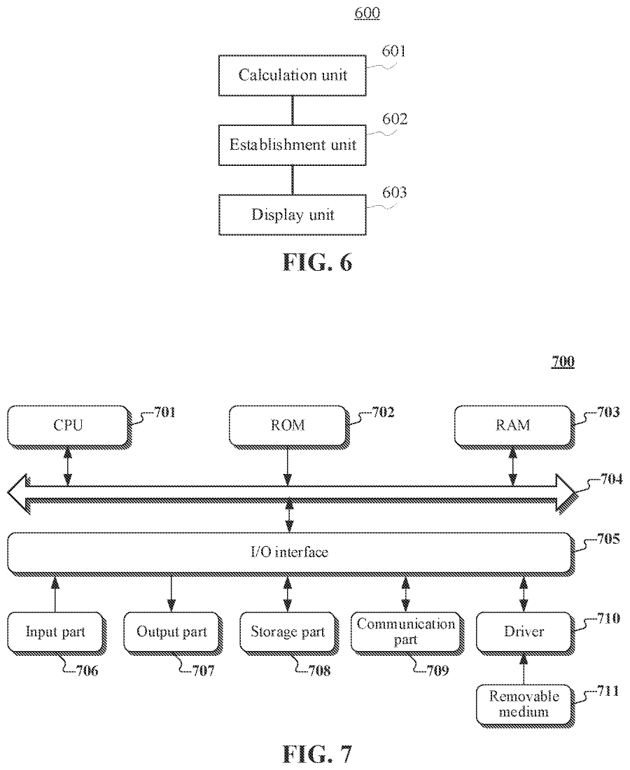

Further referring to FIG. 6, in an implementation of the method shown in the foregoing figures, the disclosure provides an embodiment of a data display apparatus. The apparatus embodiment corresponds to the method embodiment shown in FIG. 1. The apparatus is specifically applicable to various electronic devices.

As shown in FIG. 6, a data display apparatus 600 of this embodiment includes: a calculation unit 601, configured to use every two services as one service group, and calculate two-way service indicators of service groups based on service data of the service groups; an establishment unit 602, configured to establish a display unit array based on a quantity of services, each service group having a corresponding display unit in the display unit array; and a display unit 603, configured to divide each display unit into two regions, and display the two-way service indicators of each service group in the two regions of the corresponding display unit in a mirrored manner.

In some embodiments, the apparatus further includes: a setting unit, configured to detect conditions satisfied by the service indicators in each display unit, and set, based on display styles associated with the conditions, display styles of the service indicators in each display unit.

In some embodiments, the two-way service indicators of each service group include a first service indicator and a second service indicator, and the first service indicator and the second service indicator of each service group correspond to each other in a one-to-one manner.

In some embodiments, the calculation unit 601 is further configured to: determine cross resources of two services in each service group based on the service data of each service group, the cross resources including resources that are mutually outputted; and calculate, based on the cross resources of each service group, the first service indicator and the second service indicator corresponding to different output directions of the resources respectively.

In some embodiments, the calculation unit 601 is further configured to: use one service in each service group as an upstream service and the other service as a downstream service, and calculate the first service indicator based on a first resource outputted by the upstream service to the downstream service; and interchange the upstream service and the downstream service of each service group, and calculate the second service indicator based on a second resource outputted by the interchanged upstream service to the interchanged downstream service.

In some embodiments, the first service indicator includes the first resource, and a proportion of the first resource in total resources of the upstream service and/or a proportion of the first resource in total resources of the downstream service; and the second service indicator includes the second resource, and a proportion of the second resource in total resources of the interchanged upstream service and/or a proportion of the second resource in total resources of the interchanged downstream service.

In some embodiments, different rows of the display unit array correspond to different services, and different columns of the display unit array correspond to different services; and the first service indicator of each service group is a service indicator determined by using a service corresponding to a column in which a corresponding display unit is located as the upstream service and using a service corresponding to a row in which the corresponding display unit is located as the downstream service, and the second service indicator of each service group is a service indicator determined by using a service corresponding to a row in which a corresponding display unit is located as the upstream service and using a service corresponding to a column in which the corresponding display unit is located as the downstream service; or the first service indicator of each service group is a service indicator determined by using a service corresponding to a row in which a corresponding display unit is located as the upstream service and using a service corresponding to a column in which the corresponding display unit is located as the downstream service, and the second service indicator of each service group is a service indicator determined by using a service corresponding to a column in which a corresponding display unit is located as the upstream service and using a service corresponding to a row in which the corresponding display unit is located as the downstream service.

In some embodiments, the display unit 603 is further configured to: draw a diagonal line in each display unit; and display the first service indicator of each service group at one side of the diagonal line of the corresponding display unit, and display the second service indicator of each service group at the other side of the diagonal line of the corresponding display unit in a mirrored manner.

In some embodiments, the display unit 603 is further configured to: set, based on a quantity of first service indicators of each service group, display positions of the first service indicators of each service group at one side of the diagonal line of the corresponding display unit; set, based on the display positions of the first service indicators of each service group, mirror positions of second service indicators of each service group at the other side of the diagonal line of the corresponding display unit; and display, based on the determined display positions and mirror positions, the corresponding service indicators of each service group in the display unit corresponding to each service group.

In some embodiments, the establishment unit 602 is further configured to: determine a quantity of rows and a quantity of columns of the display unit array based on the quantity of services; and map different services to different rows according to a preset service arrangement order, and map different services to different columns according to the service arrangement order, to establish the display unit array including display units corresponding to the service groups.

In some embodiments, the apparatus further includes: a deployment unit, configured to: determine, based on a preset data display requirement, a layout of display units for displaying data in the display unit array; and determine, based on the layout, the display units corresponding to the service groups in the display unit array.

In some embodiments, the deployment unit is configured to: determine, in a case that the preset data display requirement is to analyze resources outputted by each service to other services, that the layout is deploying the display units corresponding to the service groups in an upper right part of the display unit array.

In some embodiments, the deployment unit is configured to: determine, in a case that the preset data display requirement is to analyze a main source of resources of each service, that the layout is deploying the display units corresponding to the service groups in a lower left part of the display unit array.

In some embodiments, both a quantity of first service indicators and a quantity of second service indicators of each service group are N, and N is a positive integer greater than or equal to 1. The display unit corresponding to each service group in the display unit array includes M² subunits that are divided uniformly, M is a positive integer greater than or equal to 2, and (M²−M)/2 is greater than or equal to N.

According to the apparatus provided in the embodiments of the disclosure, every two services are used as one service group, and two-way service indicators of service groups are calculated based on service data of the service groups; a display unit array is then established based on a quantity of services; and each display unit is finally divided into two regions, so that the two-way service indicators of each service group are displayed in the two regions of the corresponding display unit in a mirrored manner. On the one hand, the two-way service indicators of each service group can be displayed in the corresponding display unit. In addition, the two-way service indicators of each service group are displayed in a mirrored manner in the corresponding display unit, so that a two-way relationship between the services can be displayed directly and clearly, and the display units corresponding to the service groups can be concentrated in one display unit array. Therefore, the display unit array accommodates service indicators of a plurality of services having a two-way cross relationship. Therefore, such a display manner supports displaying data of services having the two-way relationship, and improves the readability of the displayed data compared with the display manner of a social network graph. On the other hand, the services may be randomly combined, and the quantity of service indicators may be customized. When the quantity of service types increases, the display unit array may be expanded to accommodate more display units. Compared with the existing data display manner, the disclosure enhances the scalability during data display.

FIG. 7 is a schematic structural diagram of a computer system 700 of an electronic device adapted to implementing any one of the data display methods according to an embodiment of the disclosure. The electronic device shown in FIG. 7 is merely an example, and is not to impose any limitation on a function and use scope of the embodiments of the disclosure.

As shown in FIG. 7, the computer system 700 includes a central processing unit (CPU) 701. The CPU 701 can perform various appropriate actions and processing according to a program stored in a read-only memory (ROM) 702 or a program loaded into a random access memory (RAM) 703 from a storage part 708. The RAM 703 further stores various programs and data required for operations of the system 700. The CPU 701, the ROM 702, and the RAM 703 are connected to each other through a bus 704. An input/output (I/O) interface 705 is also connected to the bus 704.

The following components are connected to the I/O interface 705 includes: an input part 706 including a keyboard, a mouse, etc.; an output part 707 including a liquid crystal display (LCD), a speaker, etc.; a storage part 708 including hard disk, etc.; and a communication part 709 including a network interface card such as an LAN card, a modem, etc. The communication part 709 performs communication processing by using a network such as the Internet. A driver 710 is also connected to the I/O interface 705 as required. A removable medium 711, such as a magnetic disk, an optical disc, a magneto-optical disk, or a semiconductor memory, is installed on the driver 710 as required, so that a computer program read from the removable medium is installed into the storage part 708 as required.

In particular, according to the embodiments of the disclosure, the processes described above with reference to the flowchart may be implemented as a computer software program. For example, an embodiment of the disclosure includes a computer program product, including a computer program carried on a non-transitory computer-readable medium. The computer program includes program code for performing the method shown in the flowchart. In such an embodiment, by using the communication part 709, the computer program may be downloaded and installed from a network, and/or installed from the removable medium 711. When the computer program is executed by the central processing unit (CPU) 701, the foregoing functions defined in the method of the disclosure are performed. It should be noted that, the non-transitory computer-readable medium shown in the disclosure may be a non-transitory computer-readable signal medium or a non-transitory computer-readable storage medium or any combination thereof. The non-transitory computer-readable storage medium may be, for example, but is not limited to, an electric, magnetic, optical, electromagnetic, infrared, or semi-conductive system, apparatus, or component, or any combination thereof. A more specific example of the non-transitory computer-readable storage medium may include but is not limited to: an electrical connection having one or more wires, a portable computer magnetic disk, a hard disk, a random access memory (RAM), a read-only memory (ROM), an erasable programmable read-only memory (EPROM or a flash memory), an optical fiber, a compact disk read-only memory (CD-ROM), an optical storage device, a magnetic storage device, or any appropriate combination thereof. In the disclosure, the non-transitory computer-readable storage medium may be any tangible medium containing or storing a program, and the program may be used by or used in combination with an instruction execution system, an apparatus, or a device. In the disclosure, the non-transitory computer-readable signal medium may include a data signal being in a baseband or propagated as a part of a carrier wave, the data signal carrying non-transitory computer-readable program code. The data signal propagated in such a way may assume a plurality of forms, including, but not limited to, an electromagnetic signal, an optical signal, or any appropriate combination thereof. The non-transitory computer-readable medium may be further any computer-readable medium in addition to a non-transitory computer-readable storage medium. The non-transitory computer-readable medium may send, propagate, or transmit a program that is used by or used in combination with an instruction execution system, an apparatus, or a device. The program code included in the non-transitory computer-readable medium may be transmitted by using any suitable medium, including but not limited to, wireless transmission, a wire, a cable, radio frequency (RF) or the like, or any other suitable combination thereof.

The flowcharts and block diagrams in the accompanying drawings illustrate possible system architectures, functions, and operations that may be implemented by a system, a method, and a computer program product according to various embodiments of the disclosure. In this regard, each block in the flowchart or the block diagram may represent a module, a program segment, or a part of code. The module, the program segment, or the part of the code includes one or more executable instructions for implementing a specified logical function. In some implementations used as substitutes, functions annotated in boxes may alternatively occur in a sequence different from that annotated in an accompanying drawing. For example, actually two boxes shown in succession may be performed basically in parallel, and sometimes the two boxes may be performed in a reverse sequence. This is determined by a related function. It should also be noted that, each box in a block diagram and/or a flowchart and a combination of boxes in the block diagram and/or the flowchart may be implemented by using a dedicated hardware-based system configured to perform a specified function or operation, or may be implemented by using a combination of dedicated hardware and a computer instruction.

Related units described in the embodiments of the disclosure may be implemented in a software manner, or may be implemented in a hardware manner. The units described may also be set in a processor. Names of the units do not constitute a limitation on the units in a specific case.

In another aspect, the disclosure further provides a non-transitory computer-readable medium. The non-transitory computer-readable medium may be included in the apparatus described in the above embodiments, or may exist alone without being assembled into the apparatus. The non-transitory computer-readable medium carries one or more programs. The one or more programs, when executed by the apparatus, cause the apparatus to implement any one of the data display methods according to the embodiments of the disclosure. The data display method is, for example: using every two services as one service group, and calculating two-way service indicators of service groups based on service data of the service groups; establishing a display unit array based on a quantity of services, each service group having a corresponding display unit in the display unit array; and dividing each display unit into two regions, and displaying the two-way service indicators of each service group in the two regions of the corresponding display unit in a mirrored manner.

It should be understood that, the term “and/or” used herein represents that three relationships may exist. For example, A and/or B may represent the following three cases: Only A exists, both A and B exist, and only B exists.

The foregoing descriptions are merely embodiments of the disclosure and descriptions of the technical principles used. A person skilled in the art should understand that the scope of the disclosure is not limited to the technical solutions that are formed by the foregoing particular combinations of technical features, but shall also encompass other technical solutions formed by arbitrarily combining the foregoing technical features or equivalent features thereof without departing from the foregoing inventive concept. For example, technical solutions formed by replacing the foregoing features with technical features having similar functions disclosed in the disclosure (but not limited thereto) are also included.

What is claimed is:

1. A data display method, comprising:
using every two services as one service group, and calculating two-way service indicators of service groups based on service data of the service groups;
establishing a display unit array based on a quantity of services, each service group having a corresponding display unit in the display unit array; and
dividing each display unit into two regions, and displaying the two-way service indicators of each service group in the two regions of the corresponding display unit in a mirrored manner.

2. The method according to claim 1, wherein after the displaying the two-way service indicators of each service group in the two regions of the corresponding display unit in a mirrored manner, the method further comprises:
detecting conditions satisfied by the service indicators in each display unit, and setting, based on display styles associated with the conditions, display styles of the service indicators in each display unit.

3. The method according to claim 1, wherein the two-way service indicators of each service group comprise a first service indicator and a second service indicator, and the first service indicator and the second service indicator of each service group correspond to each other in a one-to-one manner.

4. The method according to claim 3, wherein the calculating two-way service indicators of service groups based on service data of the service groups comprises:
determining cross resources of two services in each service group based on the service data of each service group, the cross resources comprising resources that are mutually outputted; and
calculating, based on the cross resources of each service group, the first service indicator and the second service indicator corresponding to different output directions of the resources respectively.

5. The method according to claim 4, wherein the calculating, based on the cross resources of each service group, the first service indicator and the second service indicator corresponding to different output directions of the resources respectively comprises:
using one service in each service group as an upstream service and the other as a downstream service, and calculating the first service indicator based on a first resource outputted by the upstream service to the downstream service; and
interchanging the upstream service and the downstream service of each service group, and calculating the second service indicator based on a second resource outputted by the interchanged upstream service to the interchanged downstream service.

6. The method according to claim 5, wherein the first service indicator comprises the first resource, and a proportion of the first resource in total resources of the upstream service and/or a proportion of the first resource in total resources of the downstream service; and the second service indicator comprises the second resource, and a proportion of the second resource in total resources of the interchanged upstream service and/or a proportion of the second resource in total resources of the interchanged downstream service.

7. The method according to claim 5, wherein different rows of the display unit array correspond to different services, and different columns of the display unit array correspond to different services; and
the first service indicator of each service group is a service indicator determined by using a service corresponding to a column in which the corresponding display unit is located as the upstream service and using a service corresponding to a row in which the corresponding display unit is located as the downstream service, and the second service indicator of each service group is a service indicator determined by using a service corresponding to a row in which the corresponding display unit is located as the upstream service and using a service corresponding to a column in which the corresponding display unit is located as the downstream service.

8. The method according to claim 1, wherein the establishing a display unit array based on a quantity of services comprises:
determining a quantity of rows and a quantity of columns of the display unit array based on the quantity of services; and
mapping different services to different rows according to a preset service arrangement order, and mapping different services to different columns according to the preset service arrangement order, to establish the display unit array comprising the display units corresponding to the service groups.

9. The method according to claim 1, wherein after the establishing a display unit array, the method further comprises:
determining, based on a preset data display requirement, a layout of display units for displaying data in the display unit array; and
determining, based on the layout, the display units corresponding to the service groups in the display unit array.

10. The method according to claim 3, wherein the dividing each display unit into two regions, and displaying the two-way service indicators of each service group in the two regions of the corresponding display unit in a mirrored manner comprises:
drawing a diagonal line in each display unit; and
displaying the first service indicator of each service group at one side of the diagonal line of the corresponding display unit, and displaying the second service indicator of each service group at the other side of the diagonal line of the corresponding display unit in a mirrored manner.

11. The method according to claim 10, wherein the displaying the first service indicator of each service group at one side of the diagonal line of the corresponding display unit, and displaying the second service indicator of each service group at the other side of the diagonal line of the corresponding display unit in a mirrored manner comprises:
setting, based on a quantity of first service indicators of each service group, display positions of the first service indicators of each service group at one side of the diagonal line of the corresponding display unit;
setting, based on the display positions of the first service indicators of each service group, mirror positions of second service indicators of each service group at the other side of the diagonal line of the corresponding display unit; and
displaying, based on the determined display positions and mirror positions, the corresponding first service indicators and second service indicators in the display unit corresponding to each service group.

12. The method according to claim 5, wherein different rows of the display unit array correspond to different services, and different columns of the display unit array correspond to different services; and
the first service indicator of each service group is a service indicator determined by using a service corresponding to a row in which the corresponding display unit is located as the upstream service and using a service corresponding to a column in which the corresponding display unit is located as the downstream service, and the second service indicator of each service group is a service indicator determined by using a service corresponding to a column in which the corresponding display unit is located as the upstream service and using a service corresponding to a row in which the corresponding display unit is located as the downstream service.

13. The method according to claim 9, wherein the determining, based on a preset data display requirement, a layout of display units for displaying data in the display unit array comprises:
determining, in a case that the preset data display requirement is to analyze resources outputted by each service to other services, that the layout is deploying the display units corresponding to the service groups in an upper right part of the display unit array.

14. The method according to claim 9, wherein the determining, based on a preset data display requirement, a layout of display units for displaying data in the display unit array comprises:
determining, in a case that the preset data display requirement is to analyze a main source of resources of each service, that the layout is deploying the display units corresponding to the service groups in a lower left part of the display unit array.

15. An electronic device, comprising:
one or more processors; and
a storage apparatus, storing one or more programs,
the one or more programs, when executed by the one or more processors, causing the one or more processors to implement a data display method, wherein the method comprises:
using every two services as one service group, and calculating two-way service indicators of service groups based on service data of the service groups;
establishing a display unit array based on a quantity of services, each service group having a corresponding display unit in the display unit array; and
dividing each display unit into two regions, and displaying the two-way service indicators of each service group in the two regions of the corresponding display unit in a mirrored manner.

16. The electronic device according to claim 15, wherein the two-way service indicators of each service group comprise a first service indicator and a second service indicator, and the first service indicator and the second service indicator of each service group correspond to each other in a one-to-one manner; and the calculating two-way service indicators of service groups based on service data of the service groups comprises:
determining cross resources of two services in each service group based on the service data of each service group, the cross resources comprising resources that are mutually outputted; and
calculating, based on the cross resources of each service group, the first service indicator and the second service indicator corresponding to different output directions of the resources respectively.

17. The electronic device according to claim 15, wherein the establishing a display unit array based on a quantity of services comprises:
determining a quantity of rows and a quantity of columns of the display unit array based on the quantity of services; and
mapping different services to different rows according to a preset service arrangement order, and mapping different services to different columns according to the preset service arrangement order, to establish the display unit array comprising the display units corresponding to the service groups.

18. The electronic device according to claim 15, wherein the two-way service indicators of each service group comprise a first service indicator and a second service indicator, and the first service indicator and the second service indicator of each service group correspond to each other in a one-to-one manner; and the dividing each display unit into two regions, and displaying the two-way service indicators of each service group in the two regions of the corresponding display unit in a mirrored manner comprises:
drawing a diagonal line in each display unit; and
displaying the first service indicator of each service group at one side of the diagonal line of the corresponding display unit, and displaying the second service indicator of each service group at the other side of the diagonal line of the corresponding display unit in a mirrored manner.

19. The electronic device according to claim 18, wherein the displaying the first service indicator of each service group at one side of the diagonal line of the corresponding display unit, and displaying the second service indicator of each service group at the other side of the diagonal line of the corresponding display unit in a mirrored manner comprises:
setting, based on a quantity of first service indicators of each service group, display positions of the first service indicators of each service group at one side of the diagonal line of the corresponding display unit;
setting, based on the display positions of the first service indicators of each service group, mirror positions of second service indicators of each service group at the other side of the diagonal line of the corresponding display unit; and
displaying, based on the determined display positions and mirror positions, the corresponding first service indicators and second service indicators in the display unit corresponding to each service group.

20. A non-transitory computer-readable medium, storing a computer program, the computer program, when executed by a processor, implementing a data display method, wherein the method comprises:
using every two services as one service group, and calculating two-way service indicators of service groups based on service data of the service groups;
establishing a display unit array based on a quantity of services, each service group having a corresponding display unit in the display unit array; and
dividing each display unit into two regions, and displaying the two-way service indicators of each service group in the two regions of the corresponding display unit in a mirrored manner.
